(19) United States
(12) Patent Application Publication
(10) Pub. No.: US 2026/0195969 A1
(43) Pub. Date: Jul. 9, 2026

(54) METHODS AND SYSTEMS FOR IMPROVED NONAFFINE VECTOR-GRAPHICS TRANSFORMATIONS

(71) Applicant: Pentrek, Inc., Chapel Hill, NC (US)

(72) Inventors: Michael Reed, Chapel Hill, NC (US); Brian Salomon, Chapel Hill, NC (US)

(21) Appl. No.: 19/380,353

(22) Filed: Nov. 5, 2025

Related U.S. Application Data
(60) Provisional application No. 63/743,089, filed on Jan. 8, 2025.

(51) Int. Cl. G06T 15/08; G06T 3/06; G06T 17/30

(52) U.S. Cl. CPC G06T 15/08; G06T 3/06; G06T 17/30

(57) ABSTRACT

A method of performing nonaffine transformations on vector graphic paths comprising multiple connected segments is provided herein. Each segment is represented as a cubic Bézier curve defined by control points. The method includes determining transformed on-curve points by mapping on-curve points of the cubic Bézier curve to a target transformation space. The method further includes determining transformed tangent vectors at the on-curve points by either applying a Jacobian matrix of the transformation mapping at the on-curve points to the tangent vectors of the original curve, or numerically approximating the transformed tangent vectors by perturbing the on-curve points in the direction of the tangent vectors and mapping the perturbed points to the target transformation space. Additionally, the method includes constructing a transformed cubic Bézier curve in the target transformation space using the transformed on-curve points and the transformed tangent vectors, wherein C¹ continuity exists between adjacent segments of the path.

### CROSS-REFERENCE TO RELATED APPLICATIONS

This application claims priority to U.S. Provisional Patent Application No. 63/743,089 filed on Jan. 8, 2025, by Pentrek, Inc., entitled “METHODS AND SYSTEMS FOR IMPROVED NON-AFFINE VECTOR-GRAPHICS TRANSFORMATIONS,” the entire content of which is incorporated by reference herein.

### TECHNICAL FIELD

The present disclosure relates to vector graphics transformations, and more particularly to methods and systems for improved nonaffine vector-graphics transformations that maintain C¹ continuity between adjacent curve segments.

### BACKGROUND

Vector graphics are widely used in digital design, web applications, and document formats due to their resolution-independent nature and scalability. These graphics are typically composed of geometric primitives such as lines, curves, and shapes that are mathematically defined rather than pixel-based. A component of vector graphics systems is the ability to transform these geometric elements through various mathematical operations to achieve desired visual effects, positioning, and styling.

Transformations in vector graphics can be broadly categorized into two types: affine and nonaffine transformations. Affine transformations, which include operations such as translation, rotation, scaling, and shearing, preserve parallel lines and maintain consistent ratios of distances along parallel lines. These transformations are mathematically straightforward to apply and can be efficiently processed by directly transforming the control points of vector graphic elements.

Nonaffine transformations, however, present more complex challenges. These transformations include operations such as perspective projections, curved distortions, and mapping graphics onto irregular surfaces or paths. Unlike affine transformations, nonaffine transformations do not preserve parallelism and can introduce complex distortions that vary across different regions of the graphic. Common applications of nonaffine transformations include text-on-a-path rendering, where text must conform to curved or irregular paths, and surface mapping operations such as those involving Coons patches.

Current approaches to nonaffine transformations typically employ a brute-force method where all control points of vector graphic elements are directly mapped to the target transformation space. While this approach can produce acceptable results in many cases, it suffers from several limitations. The direct mapping of control points often results in transformed curves that deviate from the mathematically correct transformed shape, introducing visual artifacts and reducing the fidelity of the output.

A problematic aspect of existing nonaffine transformation methods is their inability to maintain smooth transitions between adjacent curve segments. In vector graphics, maintaining continuity between connected segments is important to producing visually appealing and mathematically accurate results. First-order continuity, also known as C¹ continuity, ensures that adjacent curve segments not only meet at common endpoints but also share the same tangent direction at those points, creating smooth, flowing transitions without abrupt changes in direction.

When conventional nonaffine transformation methods are applied to connected curve segments, the independent transformation of control points can disrupt the geometric relationships that maintain C¹ continuity. This disruption results in visible discontinuities, sharp corners, or other artifacts at the junctions between segments, degrading the overall quality and appearance of the transformed graphics. Such artifacts are particularly noticeable in applications requiring high visual fidelity, such as professional graphic design, typography, and technical illustration.

The loss of continuity in nonaffine transformations represents a limitation that affects the practical utility of vector graphics in applications requiring complex geometric transformations. This limitation becomes more pronounced as the complexity of the transformation increases and as the number of connected segments in a path grows, making it difficult to achieve the smooth, professional-quality results demanded by modern graphics applications.

Accordingly, a need exists for improved methods for nonaffine vector-graphics transformations that maintain C¹ continuity between adjacent segments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one embodiment, a method is provided for performing nonaffine transformations on vector graphic paths that include multiple connected segments, where each segment is represented as a cubic Bézier curve defined by control points. The method includes determining transformed on-curve points by mapping on-curve points of the cubic Bézier curve to a target transformation space. Transformed tangent vectors are determined at the on-curve points by either applying a Jacobian matrix of the transformation mapping at the on-curve points to the tangent vectors of the original curve, or numerically approximating the transformed tangent vectors by perturbing the on-curve points in the direction of the tangent vectors and mapping the perturbed points to the target transformation space. A transformed cubic Bézier curve is constructed in the target transformation space using the transformed on-curve points and the transformed tangent vectors, where C¹ continuity exists between adjacent segments of the path.

In another embodiment, a computing system is provided that includes a processor and a memory to perform operations. The operations include determining transformed on-curve points by mapping on-curve points of a cubic Bézier curve to a target transformation space, where the cubic Bézier curve represents a segment of a vector graphic path comprising multiple connected segments. The operations further include determining transformed tangent vectors at the on-curve points by either applying a Jacobian matrix of the transformation mapping at the on-curve points to the tangent vectors of the original curve, or numerically approximating the transformed tangent vectors by perturbing the on-curve points in the direction of the tangent vectors and mapping the perturbed points to the target transformation space. The operations also include constructing a transformed cubic Bézier curve in the target transformation space using the transformed on-curve points and the transformed tangent vectors, where C¹ continuity exists between adjacent segments of the vector graphic path.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a diagram illustrating path primitives and their parametric expressions, in accordance with an aspect of the present disclosure;

FIG. 2 is a diagram illustrating different orders of continuity in curve segments, in accordance with an aspect of the present disclosure;

FIG. 3 is a diagram illustrating subdivision of a Bézier spline segment, in accordance with an aspect of the present disclosure;

FIG. 4 is a diagram illustrating chaining Bézier splines with no continuity, in accordance with an aspect of the present disclosure;

FIG. 5 is a table showing affine and nonaffine transformations, in accordance with an aspect of the present disclosure;

FIG. 6 is a diagram illustrating a three-dimensional Coons patch, in accordance with an aspect of the present disclosure;

FIG. 7 is a flowchart illustrating a method for nonaffine vector-graphics transformations, in accordance with an aspect of the present disclosure;

FIG. 8 is a diagram illustrating application of nonaffine transformation to a Bézier curve, in accordance with an aspect of the present disclosure;

FIG. 9 is a diagram illustrating differences in continuity from nonaffine transformation, in accordance with an aspect of the present disclosure;

FIG. 10 is a diagram comparing prior and improved nonaffine transformation techniques, in accordance with an aspect of the present disclosure;

FIG. 11 is a diagram illustrating text-on-a-path results using different techniques, in accordance with an aspect of the present disclosure; and

FIG. 12 is a functional block diagram of a computing system, in accordance with an aspect of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The disclosed methods and systems address challenges associated with nonaffine vector-graphics transformations by providing techniques that maintain geometric continuity between curve segments. Traditional approaches to nonaffine transformations often result in discontinuities at segment boundaries, particularly when transforming complex vector graphics that comprise multiple connected curve segments. The disclosed techniques overcome these limitations by implementing specialized mapping procedures that preserve smoothness characteristics during transformation operations.

Vector graphics transformations may involve mapping geometric elements from one coordinate space to another through mathematical functions that alter the spatial relationships between points, curves, and surfaces. Nonaffine transformations present challenges because these transformations do not preserve linear relationships between geometric elements, unlike affine transformations that maintain properties such as parallelism and proportional distances. When nonaffine transformations are applied to vector graphics containing multiple connected curve segments, conventional methods may produce results where adjacent segments meet at common points but exhibit abrupt changes in direction or curvature at these junction points.

The disclosed systems and methods provide enhanced approaches for handling nonaffine transformations by focusing on the preservation of C¹ continuity between adjacent curve segments. C¹ continuity refers to a mathematical property where curves not only meet at common endpoints but also share identical tangent directions at these connection points. This continuity property ensures smooth transitions between curve segments and maintains the visual and geometric integrity of the transformed graphics. The disclosed techniques achieve this continuity by implementing specialized procedures for mapping both positional information and directional information during the transformation process.

In some cases, the disclosed methods may be applied to vector graphics that contain cubic Bézier curves, which are commonly used in digital graphics applications due to their flexibility and mathematical properties. Cubic Bézier curves are defined by four control points that determine the shape and position of the curve segment. When multiple cubic Bézier curves are connected to form complex paths or shapes, maintaining continuity between these segments becomes particularly challenging during nonaffine transformations. The disclosed techniques address these challenges by implementing mapping procedures that account for both the geometric positions of curve elements and their associated directional characteristics.

The disclosed systems may incorporate computational approaches that use mathematical techniques such as Jacobian matrix calculations or numerical approximation methods to determine appropriate transformations for curve elements. These computational approaches enable the systems to maintain geometric relationships between curve segments while adapting to the nonlinear distortions introduced by nonaffine transformation functions. The resulting transformed graphics exhibit improved fidelity compared to conventional transformation methods, particularly in applications where smooth curve transitions are desired or where visual quality is a consideration.

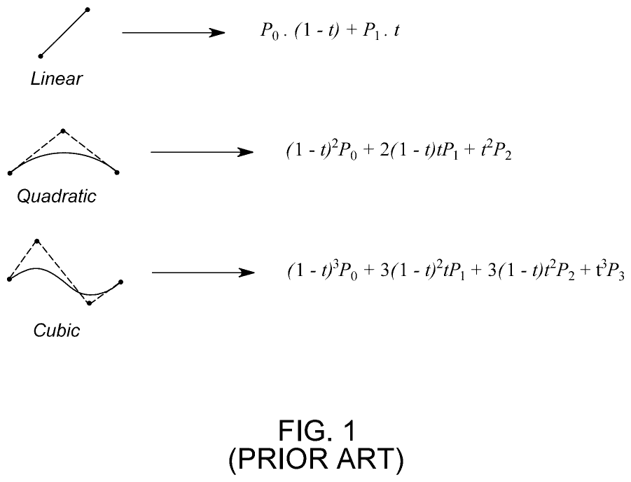

FIG. 1 illustrates three types of path primitives and their corresponding parametric expressions according to various embodiments. Vector graphics systems use mathematical representations to define geometric shapes through parametric curves that may be scaled and manipulated without loss of resolution. The building blocks of these vector graphics systems include three primary curve types that provide varying degrees of complexity and control over the resulting geometric shapes. These curve types may be used to form more complex vector graphics operations and transformations.

A linear path represents the simplest form of vector graphics primitive, defined by two endpoint coordinates that determine a straight line segment between the specified positions. The mathematical representation of a linear path follows the parametric form P(t)=(1−t)A+tB, where A and B represent the endpoint coordinates and t varies from 0 to 1 to define positions along the line segment. This parametric expression allows for precise calculation of any point along the linear path by substituting appropriate values of the parameter t. Linear paths may be used to create more complex geometric constructions and provide computational efficiency when simple straight-line connections are sufficient for the desired visual representation.

A quadratic path provides increased flexibility compared to linear paths by incorporating a single control point that influences the curvature of the resulting curve segment. The parametric expression for a quadratic path takes the form P(t)=(1−t)²A +2t(1−t)B+t²C, where A and C represent the endpoint coordinates and B represents the control point that determines the curve's shape and direction. The quadratic formulation enables the creation of smooth curved segments that may approximate more complex shapes while maintaining computational efficiency. The control point B influences the curve's trajectory by attracting the path toward the control point position, with the degree of influence varying based on the parameter t value.

A cubic path represents the most flexible of the three primitive types, utilizing four control points to define complex curve segments with precise control over both position and curvature characteristics. The parametric expression for a cubic path follows the form P(t)=(1−t)³A+3t(1−t)²B+3t²(1−t)C+t³D, where A and D represent the endpoint coordinates while B and C serve as control points that determine the curve's shape and directional properties. Cubic paths provide the mathematical basis for Bézier curves, which are widely used in computer graphics applications due to their ability to represent smooth, aesthetically pleasing curves with intuitive control mechanisms. The four-point control system allows for independent adjustment of the curve's departure angle from the starting point and arrival angle at the ending point, enabling precise control over the curve's geometric properties.

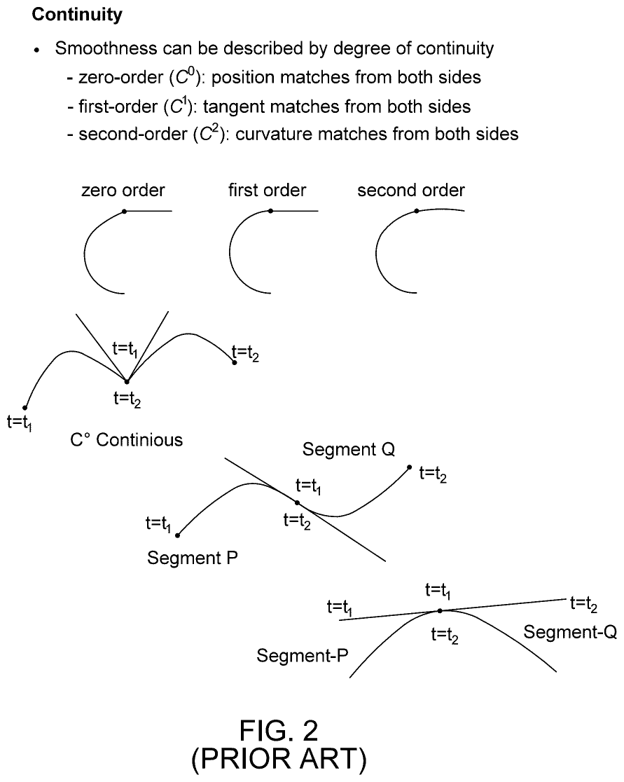

FIG. 2 illustrates different orders of continuity in curve segments according to various embodiments. When multiple curve segments are connected to form complex paths or shapes, the smoothness of the transitions between segments becomes a consideration for visual quality and mathematical properties. The concept of parametric continuity describes the degree of smoothness achieved at the junction points where individual curve segments meet. Different orders of continuity provide varying levels of smoothness, with higher orders resulting in more seamless transitions between connected segments.

Zero-order continuity, designated as C⁰, represents the most basic level of connection between curve segments, where adjacent segments share common endpoint coordinates but may exhibit abrupt changes in direction at the junction point. At a first time point t₁ and a second time point t₂, C⁰ continuity ensures that the ending position of one segment matches the starting position of the subsequent segment, providing positional continuity without guaranteeing smoothness in the transition. This level of continuity may be sufficient for applications where sharp corners or angular transitions are desired, such as in geometric shapes or technical drawings where precise angular relationships are specified.

First-order continuity, designated as C¹, extends beyond positional matching to include alignment of the tangent vectors at the junction points between adjacent curve segments. This level of continuity ensures that the direction of the curve remains consistent across segment boundaries, eliminating abrupt changes in the curve's trajectory at connection points. C¹ continuity provides smooth directional transitions that are visually appealing and mathematically well-behaved, making this level of continuity desirable for applications such as font design, logo creation, and artistic illustrations where smooth flowing lines enhance the visual quality of the result.

Second-order continuity, designated as C², provides the highest level of smoothness by ensuring that both the tangent vectors and the curvature values remain consistent across segment boundaries. This level of continuity eliminates not only directional discontinuities but also abrupt changes in the rate of curvature, resulting in extremely smooth transitions that appear natural and aesthetically pleasing even under close examination or magnification. C² continuity may be particularly valuable in applications where the vector graphics will be subjected to scaling operations or where the smoothness of curves directly impacts the quality of the final output.

The disclosed transformation methods may accommodate different types of path primitives by converting linear path and quadratic path segments to cubic Bézier curve representations before applying nonaffine transformation operations. This conversion process enables uniform handling of all curve types while maintaining the mathematical properties and geometric characteristics of the original path segments. For a linear path defined by endpoints U and V, the conversion to cubic form uses specific control point calculations where A=U, B=U ×(2/3)+V×(1/3), C=U×(1/3)+V×(2/3), and D=V. This conversion preserves the linear characteristics of the original path while providing the four-point control structure required for cubic Bézier curve processing.

Similarly, a quadratic path defined by control points U, V, and W may be converted to cubic form using the relationships A =U, B=U×(1/3)+V×(2/3), C=W×(1/3)+V×(2/3), and D=W. This conversion maintains the curvature properties of the original quadratic path while enabling the use of cubic Bézier curve transformation algorithms. The conversion process ensures that the geometric properties of the original path segments are preserved while providing a consistent mathematical framework for applying nonaffine transformations across different primitive types.

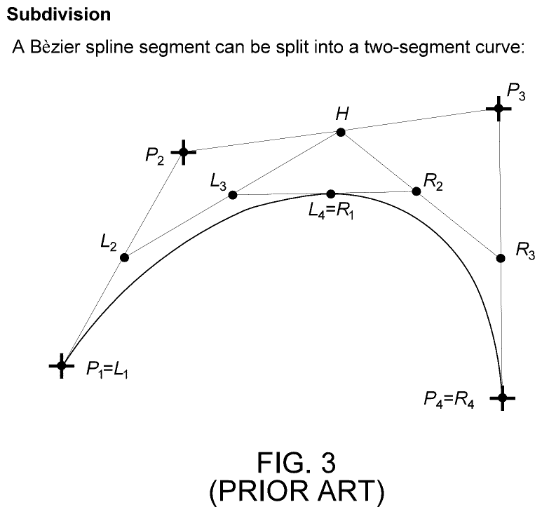

FIG. 3 illustrates subdivision of a Bézier spline segment into two segments according to various embodiments. The subdivision process enables the decomposition of complex curve segments into smaller, more manageable components while preserving the geometric properties and mathematical characteristics of the original curve. This subdivision enables adaptive refinement of curves based on accuracy requirements or transformation constraints.

The original Bézier spline segment may be defined by a first endpoint P1, a second endpoint P4, a first control point P2, and a second control point P3. These four control points establish the mathematical basis for the cubic Bézier curve, with the first endpoint P1 and the second endpoint P4 serving as the terminal points of the curve segment. The first control point P2 and the second control point P3 influence the curvature and directional properties of the curve, determining how the path deviates from a straight line connection between the first endpoint P1 and the second endpoint P4. The positioning of the first control point P2 affects the departure angle and initial curvature of the curve as the path leaves the first endpoint P1, while the second control point P3 influences the arrival angle and final curvature as the curve approaches the second endpoint P4.

The subdivision process transforms the original four-point curve segment into two separate curve segments, each maintaining the cubic Bézier mathematical structure while representing a portion of the original curve's geometry. The first subdivided segment may be characterized by a first segment start point L1, a first segment first control point L2, a first segment second control point L3, and a first segment end point L4. Similarly, the second subdivided segment may be defined by a second segment start point R1, a second segment first control point R2, a second segment second control point R3, and a second segment end point R4. The subdivision process establishes specific mathematical relationships between these points to ensure that the combined geometry of the two segments accurately represents the original curve.

The subdivision operation maintains geometric continuity by establishing that the first endpoint P1 corresponds to the first segment start point L1, ensuring that the beginning of the first subdivided segment matches the beginning of the original curve. The connection between the two subdivided segments occurs at the shared point where the first segment end point L4 equals the second segment start point R1, providing positional continuity between the segments. The second endpoint P4 corresponds to the second segment end point R4, ensuring that the end of the second subdivided segment matches the end of the original curve. These relationships guarantee that the subdivided segments, when considered together, span the same geometric space as the original curve segment.

The method may use adaptive subdivision with the De Casteljau algorithm for splitting the cubic path into smaller segments. The De Casteljau algorithm provides a mathematically robust approach for curve subdivision that maintains numerical stability and preserves the geometric properties of the original curve. This algorithm operates through a series of linear interpolations between the control points, progressively refining the point positions to determine the control points for the subdivided segments. The algorithm begins by selecting a parameter value along the curve to determine the subdivision point, then applies iterative linear interpolation operations to calculate the intermediate points that define the control points for the resulting segments.

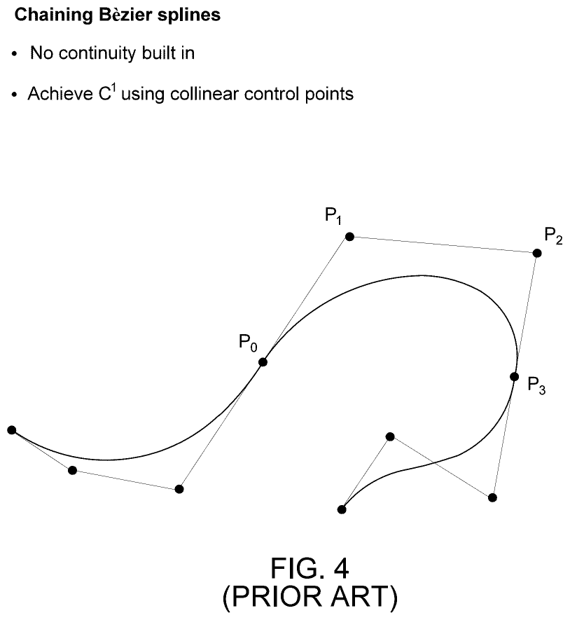

FIG. 4 illustrates combining multiple Bézier spline segments using collinear control points to achieve C¹ continuity between the segments according to various embodiments. The connection of multiple curve segments presents challenges related to maintaining smoothness and continuity at the junction points where individual segments meet. Conventional approaches for achieving C¹ continuity between connected segments may impose constraints on the positioning of control points that can limit the flexibility and design freedom available when creating complex vector graphics paths.

The connection process includes establishing relationships between the control points of adjacent segments to ensure smooth transitions at a first junction point P0. The first junction point P0 serves as the shared connection point where multiple curve segments meet, requiring careful coordination of the control point positions to achieve the desired continuity properties. The positioning of control points adjacent to the first junction point P0 influences the tangent directions of the connected segments, with the alignment of these tangent directions determining whether C¹ continuity may be achieved at the connection point.

Conventional approaches for achieving C¹ continuity may require that control points positioned immediately before and after the first junction point P0 be placed along the same linear path. This collinear arrangement ensures that the tangent vector of the ending segment matches the tangent vector of the beginning segment at the first junction point P0, providing the directional continuity characteristic of C¹ smoothness. However, this constraint may limit the design flexibility available when creating complex curve paths, as the requirement for collinear control points restricts the range of curvature and directional changes that may be achieved at segment boundaries.

The limitations of conventional approaches become apparent when attempting to create complex vector graphics that require both smooth continuity and diverse geometric characteristics. The collinear control point requirement may prevent the creation of certain curve shapes or may force designers to use additional curve segments to achieve desired geometric effects. These limitations may impact the efficiency of vector graphics representations and may complicate the editing and modification processes for complex graphics designs. The disclosed nonaffine transformation methods address these limitations by providing alternative approaches for maintaining C¹ continuity that do not rely solely on collinear control point arrangements, enabling greater flexibility in vector graphics design while preserving the smoothness characteristics desired for high-quality visual output.

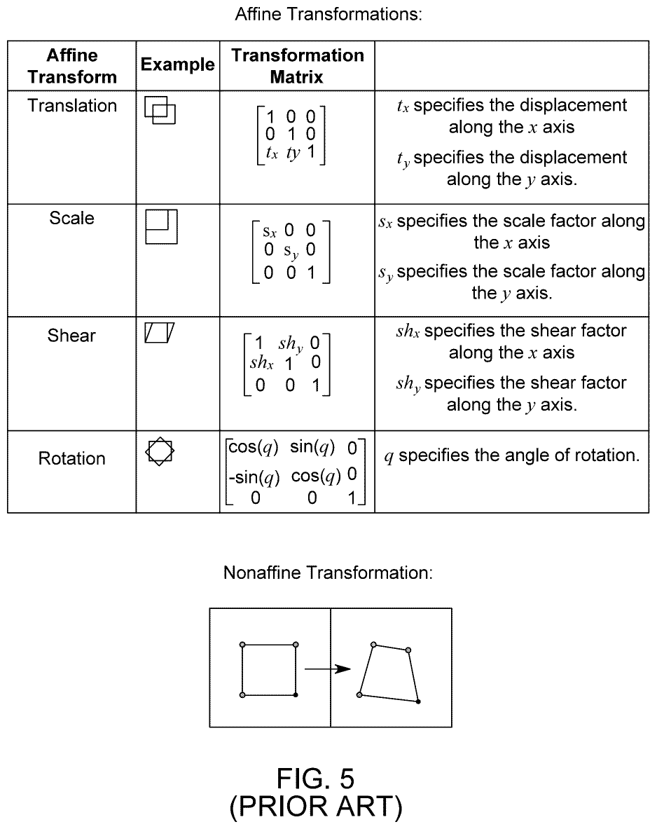

FIG. 5 illustrates differences between affine and nonaffine transformations according to various embodiments. Mathematical transformations in vector graphics may be categorized into two primary classes based on their geometric properties and the mathematical relationships they preserve during the transformation process. Affine transformations maintain specific geometric properties such as parallelism, collinearity, and proportional distances along parallel lines, while nonaffine transformations introduce nonlinear distortions that alter these geometric relationships. The distinction between these transformation types becomes particularly relevant when processing complex vector graphics that contain multiple connected curve segments, as the choice of transformation approach directly impacts the geometric integrity and visual characteristics of the resulting output.

Affine transformations encompass a range of mathematical operations including translation, scaling, rotation, and shear transformations, each of which preserves the linear relationships between geometric elements within the vector space. Translation operations shift all points in the vector space by a constant offset vector, maintaining the relative positions and orientations of geometric elements while changing their absolute coordinates. Scaling transformations multiply coordinate values by specified factors, enabling uniform or non-uniform resizing of geometric elements while preserving their proportional relationships. Rotation transformations apply trigonometric functions to coordinate values, changing the orientation of geometric elements while maintaining their shapes and relative positions. Shear transformations introduce controlled distortions that maintain parallelism while altering the angles between geometric elements.

The mathematical properties of affine transformations enable efficient processing of vector graphics through direct application of transformation matrices to the control points of curve segments. When an affine transformation matrix is applied to the control points of a cubic path, the resulting transformed curve maintains the same mathematical structure and geometric properties as the original curve. This preservation of mathematical relationships allows for straightforward computation of transformed vector graphics without the need for complex approximation algorithms or iterative refinement procedures. The linear nature of affine transformations ensures that the transformation of individual control points produces mathematically accurate results for the entire curve segment.

Nonaffine transformations introduce mathematical complexities that extend beyond the linear relationships preserved by affine operations. These transformations may involve nonlinear distortions such as perspective projections, curved surface mappings, or arbitrary mathematical functions that alter the geometric relationships between points and curves. The nonlinear nature of these transformations means that direct application of transformation functions to control points may not produce accurate representations of the transformed curves, as the mathematical relationships between control points and the resulting curve geometry are altered by the nonlinear transformation process.

The challenges associated with nonaffine transformations become apparent when attempting to maintain geometric accuracy and visual quality during the transformation process. Unlike affine transformations, where the transformation of control points directly produces the correct transformed curve, nonaffine transformations may introduce distortions that cause the transformed control points to generate curves that deviate from the mathematically correct result. These deviations may manifest as changes in curvature, alterations in the smoothness of curve transitions, or disruptions in the continuity properties between connected curve segments.

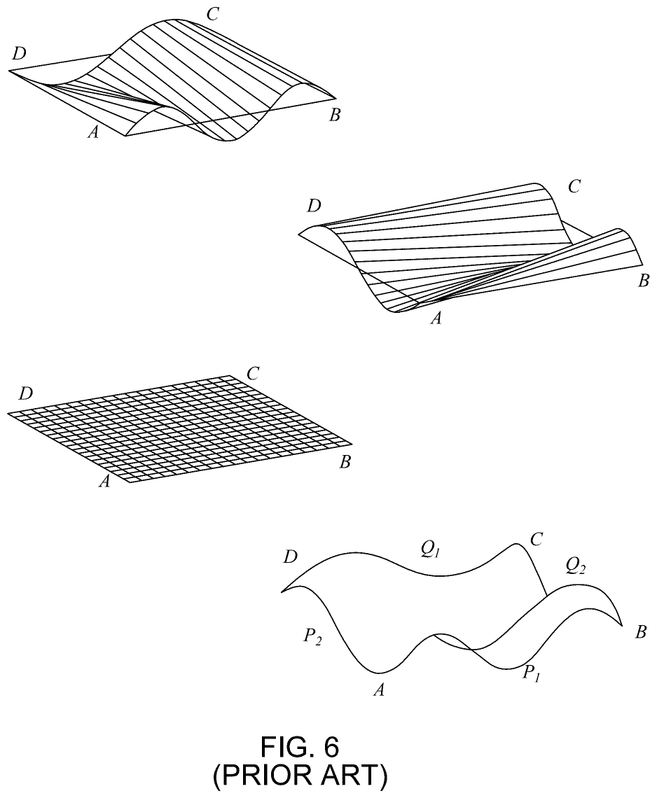

FIG. 6 illustrates a three-dimensional Coons patch and its components according to various embodiments. Coons patch transformations represent a specific category of nonaffine transformations that enable the mapping of two-dimensional geometric elements onto three-dimensional curved surfaces through mathematical interpolation techniques. The Coons patch approach provides a framework for creating smooth surface interpolations between defined boundary curves, enabling the transformation of planar vector graphics into complex three-dimensional representations while maintaining controlled geometric relationships between the original and transformed elements.

The mathematical basis of Coons patch transformations involves the definition of boundary curves that establish the geometric constraints for the surface interpolation process. A third boundary curve Q1 and a fourth boundary curve Q2 may serve as opposing boundary elements that define the spatial limits of the interpolation surface. These boundary curves provide the mathematical constraints that guide the interpolation process, ensuring that the resulting surface maintains specific geometric relationships with the defined boundary elements. The third boundary curve Q1 and the fourth boundary curve Q2 may be positioned to create a ruled surface that interpolates smoothly between the specified boundary conditions.

The Coons patch interpolation process operates through a series of mathematical operations that combine the influences of the boundary curves to determine the position and orientation of interior points within the transformation space. The interpolation calculations involve blending functions that weight the contributions of different boundary curves based on the parametric coordinates of the point being transformed. This blending process ensures that points near the boundary curves are strongly influenced by the geometric properties of those boundaries, while points in the interior regions receive balanced contributions from multiple boundary elements.

The transformation may map a source square containing a Bézier curve to a transformed square using Coons patch interpolation. The source square provides the initial geometric framework for the transformation, with the contained Bézier curve representing the vector graphics element that will be subjected to the nonaffine transformation process. The Coons patch interpolation applies mathematical functions that map each point within the source square to a corresponding position within the transformed coordinate space, with the mapping function determined by the boundary curve definitions and the interpolation parameters specified for the transformation operation.

The three-dimensional surface interpolation capabilities of Coons patch transformations enable the creation of complex curved surfaces that maintain smooth transitions between boundary elements while providing controlled distortion of interior geometric features. The interpolation process ensures that the resulting surface maintains mathematical continuity across the entire transformation domain, preventing the introduction of discontinuities or abrupt changes in surface curvature that could compromise the visual quality of the transformed vector graphics. The mathematical properties of the Coons patch approach enable precise control over the degree and distribution of distortion applied to the transformed elements, allowing for the creation of aesthetically pleasing results that maintain the geometric integrity of the original vector graphics while adapting to the constraints imposed by the three-dimensional surface geometry.

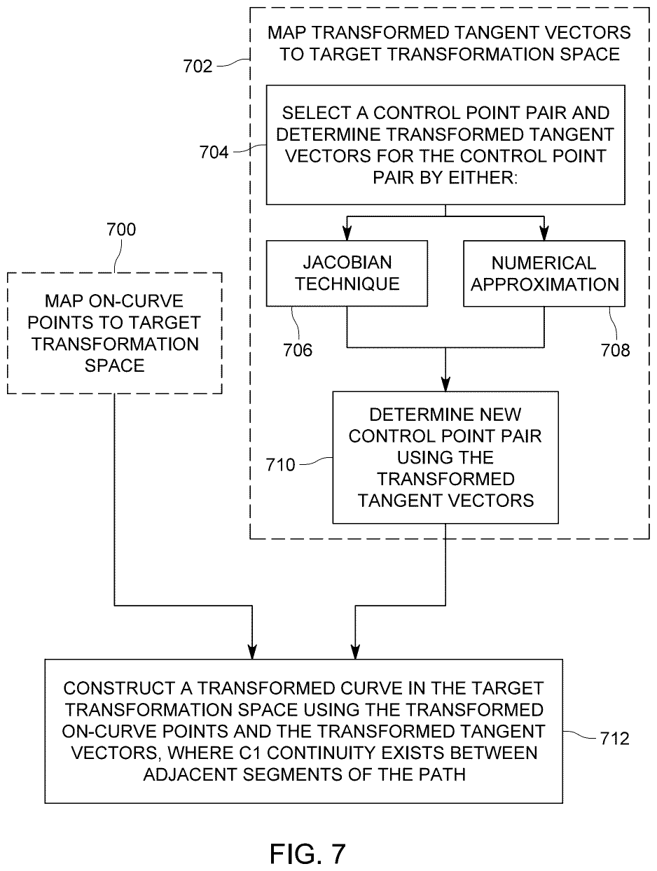

FIG. 7 illustrates an improved method for nonaffine vector-graphics transformations according to various embodiments. The improved method addresses the limitations of conventional transformation approaches by implementing specialized procedures that maintain C¹ continuity between adjacent curve segments during nonaffine transformation operations. The method operates on vector graphic paths comprising multiple connected segments, where each segment may be represented as a cubic path defined by control points. The transformation process includes a series of coordinated steps that map both positional and directional information from the original coordinate space to a target transformation space while preserving the geometric relationships necessary for smooth curve transitions.

The method for determining transformed on-curve points begins at step 700 by mapping on-curve points of the cubic path to a target transformation space. This initial operation 700 establishes the geometric relationships for the transformation process by identifying specific points along the original curve segments and calculating their corresponding positions within the target coordinate system. The on-curve points represent actual positions along the mathematical curve defined by the cubic path, as distinguished from the control points that influence the curve's shape but may not lie directly on the curve itself. The mapping operation 700 applies the nonaffine transformation function to these on-curve points, producing transformed coordinates that serve as anchor points for the reconstructed curve segments in the target space.

The transformation mapping 700 may be defined by a function from [symbol] ² to [symbol] ² that preserves the geometric integrity of the path during the coordinate space conversion process. The mathematical function encompasses the nonlinear relationships that characterize nonaffine transformations, enabling the method to handle complex geometric distortions such as perspective projections, curved surface mappings, or arbitrary mathematical transformations that extend beyond the linear relationships preserved by affine operations. The preservation of geometric integrity ensures that the essential characteristics of the original vector graphics are maintained throughout the transformation process, preventing the introduction of unwanted artifacts or distortions that could compromise the visual quality or mathematical properties of the resulting output.

Step 702 encompasses several steps that involve mapping transformed tangent vectors of the cubic path to the target transformation space, with the process beginning with step 704 which selects a control point pair and determining transformed tangent vectors for the control point pair. Step 704 provides flexibility in the transformation approach by offering two alternative techniques for calculating the transformed tangent vectors, each with distinct computational characteristics and accuracy properties. The selection between these techniques may be based on factors such as computational efficiency requirements, accuracy specifications, or the mathematical properties of the specific transformation function being applied.

Step 706 includes applying a Jacobian matrix of the transformation mapping at the on-curve points to the tangent vectors of the original curve. The Jacobian matrix may be computed as a 2×2 matrix representing a local linear approximation of the transformation mapping at the on-curve points. The Jacobian approach uses mathematical differentiation techniques to determine how the transformation function affects directional vectors at specific points within the coordinate space. The 2×2 matrix structure accommodates two-dimensional vector graphics operations while providing the mathematical framework necessary for accurate tangent vector transformation. The local linear approximation property of the Jacobian matrix enables the method to capture the directional effects of the nonaffine transformation without requiring complex nonlinear calculations for each tangent vector operation.

Alternatively, step 708 includes numerically approximating the transformed tangent vectors by perturbing the on-curve points in the direction of the tangent vectors and mapping the perturbed points to the target transformation space. The numerical approximation technique provides a computational alternative to the Jacobian approach that may be particularly useful when the mathematical derivatives of the transformation function are difficult to calculate or when the transformation includes complex mathematical operations that do not lend themselves to analytical differentiation. The perturbation process involves creating small displacement vectors along the tangent directions and observing how these displacements are affected by the transformation function.

The tangent vector perturbation in the numerical approximation approach may be scaled by a factor inversely proportional to the length of the tangent vector. The factor may be computed as k divided by the length of the tangent vector, where k represents a small distance relative to the size of the segment. This scaling approach ensures that the perturbation magnitude remains appropriate for the local geometric characteristics of the curve segment, preventing numerical instabilities that could arise from excessive perturbation distances or insufficient sensitivity to directional changes. The numerical approximation technique scales the final tangent vector by 1/e where e represents the perturbation factor originally used, providing mathematical consistency between the perturbation magnitude and the resulting tangent vector calculation.

Step 710 includes determining a new control point pair using the transformed tangent vectors obtained through either the Jacobian or numerical approximation techniques. Step 710 establishes the mathematical relationships between the transformed on-curve points and their associated tangent vectors, allowing for reconstructing the cubic path segments in the target transformation space. The control point pair determination process uses the geometric properties of cubic path mathematics to calculate control point positions that will produce curve segments with the desired endpoint positions and tangent directions. The transformed tangent vectors may be further scaled to normalize their lengths based on the magnitude of the original tangent vectors, ensuring that the reconstructed curve segments maintain appropriate geometric proportions relative to the original curve characteristics.

Step 712 includes constructing a transformed cubic path in the target transformation space using the transformed on-curve points and the transformed tangent vectors, where C¹ continuity exists between adjacent segments of the path. Step 712 represents the culmination of the transformation process, where the individually processed curve segments are assembled into a complete vector graphics representation that maintains the smoothness properties desired for high-quality visual output. The method may use cubic Hermite formulation to reconstruct the transformed curve using mapped endpoints and transformed tangents, providing mathematical precision in the curve reconstruction process while ensuring that the resulting segments exhibit the proper geometric relationships.

The transformed cubic path may be defined using a pair of transformed control points, a pair of transformed tangent points, and a pair of terminal points in the target transformation space. This mathematical structure provides the complete specification necessary for representing the transformed curve segments within standard vector graphics frameworks and file formats. The C¹ continuity property ensures that adjacent segments not only meet at common endpoints but also share identical tangent directions at these connection points, eliminating abrupt changes in curve direction that could compromise the visual smoothness of the transformed graphics.

The method may include a step of subdividing a segment of the transformed cubic path into smaller segments when an error between the transformed segment and the target transformation exceeds a predetermined threshold. Error estimation may be performed by sampling points at parameter values t=0.25, 0.5, 0.75 along the curve, providing systematic evaluation of the transformation accuracy at multiple locations within each curve segment. The subdivisions may be performed iteratively until the error falls within the predetermined threshold while maintaining C¹ continuity between segments, ensuring that the final result achieves the desired balance between computational efficiency and geometric accuracy. The transformed path may be used to render vector graphics in formats comprising Scalable Vector Graphics (SVG), PDF, or PostScript, enabling integration with standard graphics processing workflows and applications.

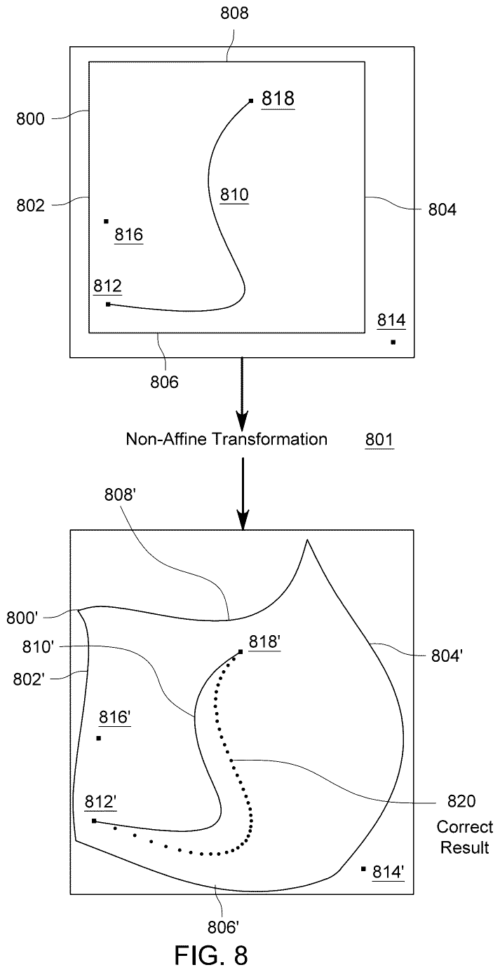

FIG. 8 illustrates applying a nonaffine transformation to a two-dimensional square that includes a Bézier curve to a two-dimensional Coons patch that includes the Bézier curve according to various embodiments. The transformation process demonstrates the application of the disclosed methods to practical vector graphics scenarios where geometric elements undergo complex spatial mappings that extend beyond the linear relationships preserved by affine transformations. The example provides a concrete illustration of how the improved transformation techniques handle the challenges associated with maintaining geometric accuracy and continuity properties during nonaffine transformation operations.

A source square 800 provides the initial geometric framework for the transformation operation, with the square defined by four boundary edges that establish the spatial limits of the transformation domain. A left edge 802, a right edge 804, a bottom edge 806, and a top edge 808 define the rectangular boundary of the source square 800, creating a well-defined coordinate space for the vector graphics elements contained within the square. The rectangular geometry of the source square 800 provides a mathematically convenient starting point for demonstrating the effects of nonaffine transformations, as the regular geometric properties of the square enable clear visualization of the distortions introduced by the transformation process.

A source Bézier curve 810 within the source square 800 represents the vector graphics element that will be subjected to the nonaffine transformation process. The source Bézier curve 810 may be defined by geometric control points that determine the curve's shape and spatial characteristics within the coordinate system of the source square 800. A start point 812 and an end point 818 establish the terminal positions of the source Bézier curve 810, while a first control point 814 and a second control point 816 influence the curvature and directional properties of the curve segment. The positioning of the first control point 814 affects the departure characteristics of the source Bézier curve 810 as the curve extends from the start point 812, while the second control point 816 influences the arrival characteristics as the curve approaches the end point 818.

A nonaffine transformation 801 applies mathematical operations that map the geometric elements of the source square 800 to corresponding positions within a target coordinate space. The nonaffine transformation 801 introduces nonlinear distortions that alter the geometric relationships between points, lines, and curves within the transformation domain. Unlike affine transformations that preserve properties such as parallelism and proportional distances, the nonaffine transformation 801 may introduce complex spatial distortions that require specialized processing techniques to maintain the geometric integrity and visual quality of the transformed vector graphics elements.

The transformation process produces a transformed square 800′ that represents the result of applying the nonaffine transformation 801 to the source square 800. The transformed square 800′ exhibits the geometric distortions characteristic of nonaffine transformations, with the originally rectangular boundary of the source square 800 becoming a curved or warped shape that reflects the mathematical properties of the transformation function. A transformed left edge 802′, a transformed right edge 804′, a transformed bottom edge 806′, and a transformed top edge 808′ define the boundary of the transformed square 800′, with each edge exhibiting curvature or distortion that results from the nonlinear mapping operations of the nonaffine transformation 801.

A transformed Bézier curve 810′ represents the result of applying the nonaffine transformation 801 to the source Bézier curve 810 using conventional transformation approaches that map control points directly without accounting for the specialized requirements of nonaffine operations. The transformed Bézier curve 810′connects a transformed start point 812′ and a transformed end point 818′, with a transformed first control point 814′ and a transformed second control point 816′ defining the curve's geometric properties within the coordinate system of the transformed square 800′. The direct mapping of control points may introduce geometric inaccuracies that cause the transformed Bézier curve 810′ to deviate from the mathematically correct result of the nonaffine transformation 801.

A correct curve 820 represents the mathematically accurate result that should be obtained when the nonaffine transformation 801 is applied to the source Bézier curve 810 using precise mathematical techniques that account for the nonlinear properties of the transformation function. The correct curve 820 serves as a reference standard for evaluating the accuracy of different transformation approaches, providing a benchmark against which the geometric fidelity of various transformation techniques may be assessed. The deviation between the transformed Bézier curve 810′ and the correct curve 820 illustrates the limitations of conventional transformation approaches when applied to nonaffine operations, demonstrating the need for improved techniques that can maintain geometric accuracy during complex transformation processes.

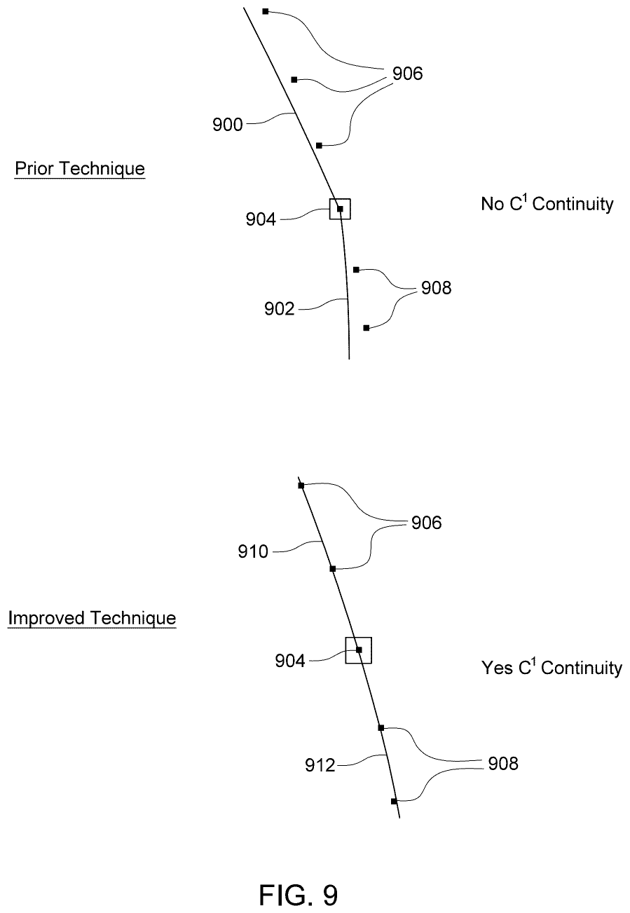

FIG. 9 illustrates differences in continuity where two segments of a curve are joined resulting from a nonaffine transformation between a prior technique and an improved technique according to various embodiments. The comparison demonstrates the advantages of the disclosed transformation methods in maintaining C¹ continuity between adjacent curve segments during nonaffine transformation operations. The visual representation provides clear evidence of how conventional transformation approaches may introduce discontinuities at segment boundaries, while the improved techniques preserve the smoothness properties that are desirable for high-quality vector graphics applications.

The upper portion of the figure illustrates the results obtained using conventional transformation techniques that apply nonaffine transformations directly to control points without specialized processing for continuity preservation. A first curve segment 900 and a second curve segment 902 meet at a junction point 904, representing the connection between adjacent segments in a multi-segment vector graphics path. The conventional transformation approach may produce segments that meet at the junction point 904 but exhibit abrupt changes in direction or curvature at the connection point, resulting in a loss of C¹ continuity that compromises the visual smoothness of the transformed graphics. This portion is labeled “No C¹ Continuity” to indicate the discontinuous nature of the connection.

A first correct point 906 and a second correct point 908 represent the mathematically accurate positions that the curve segments should occupy when the nonaffine transformation is applied using precise mathematical techniques. The deviation between the actual positions of the first curve segment 900 and the second curve segment 902 and the positions indicated by the first correct point 906 and the second correct point 908 illustrates the geometric inaccuracies introduced by conventional transformation approaches. These deviations may manifest as visible discontinuities or irregularities in the transformed graphics, particularly when the vector graphics are subjected to scaling operations or close examination.

The lower portion of the figure demonstrates the results obtained using the improved transformation techniques disclosed herein, which maintain C¹ continuity between adjacent segments during nonaffine transformation operations. An improved first segment 910 and an improved second segment 912 meet at the junction point 904 with geometric properties that closely match the positions indicated by the first correct point 906 and the second correct point 908. The improved transformation approach ensures that the improved first segment 910 and the improved second segment 912 not only meet at a common endpoint but also share identical tangent directions at the junction point 904, providing the smooth directional transitions characteristic of C¹ continuity. This portion is labeled “Yes C¹ Continuity” to indicate the smooth, continuous nature of the connection.

The comparison between the conventional and improved approaches illustrates the technical advantages achieved by the disclosed transformation methods. The improved first segment 910 and the improved second segment 912 exhibit geometric properties that more closely approximate the correct curve 820, demonstrating enhanced accuracy in the transformation process. The preservation of C¹ continuity ensures that the transformed graphics maintain the visual smoothness and mathematical properties that are desirable for professional graphics applications, while the improved geometric accuracy reduces the visual artifacts that may be introduced by conventional transformation techniques.

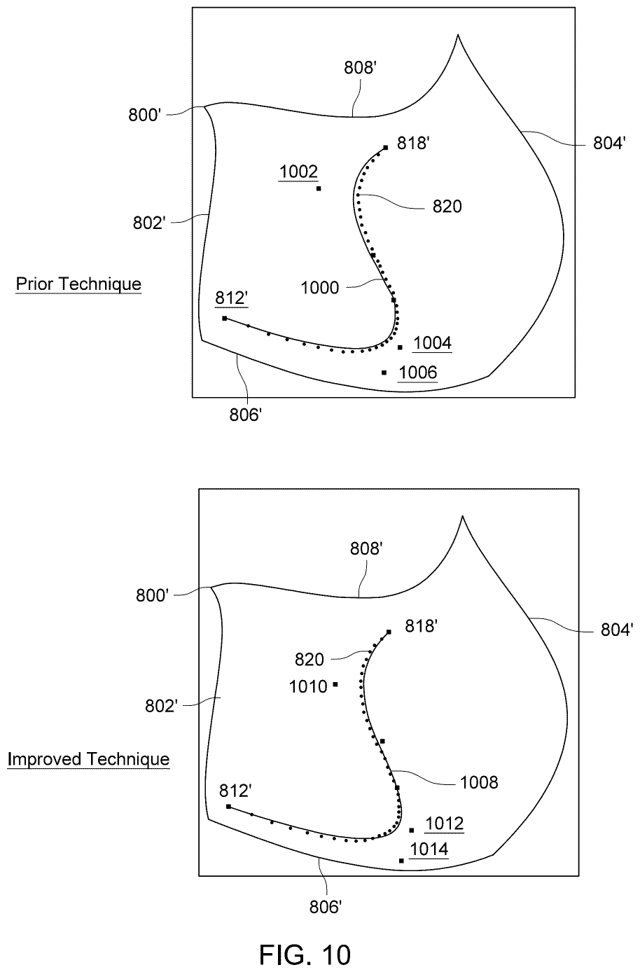

FIG. 10 illustrates differences between two-dimensional Coons patches after application of a nonaffine transformation using a prior technique and an improved technique according to various embodiments. The comparison provides a comprehensive evaluation of transformation accuracy across multiple points along the curve segments, demonstrating how the improved techniques achieve better geometric fidelity throughout the entire transformation domain. The visual representation enables quantitative assessment of the improvements achieved by the disclosed methods compared to conventional transformation approaches.

The figure depicts the transformation of the source square 800 defined by the left edge 802, the right edge 804, the bottom edge 806, and the top edge 808. The start point 812 and the end point 818 establish the terminal positions of the curve segment within the source square 800, providing reference points for evaluating the accuracy of the transformation process. The geometric framework established by these elements provides a consistent basis for comparing the results obtained using different transformation techniques.

The upper portion of the figure illustrates the results obtained using conventional transformation approaches, showing a prior transformed curve 1000 that represents the output of direct control point mapping techniques applied to nonaffine transformations. The prior transformed curve 1000 exhibits deviations from the correct curve 820 at multiple locations along the curve segment, with a first deviation point 1002, a second deviation point 1004, and a third deviation point 1006 indicating specific locations where the conventional approach produces geometric inaccuracies. These deviation points demonstrate that the errors introduced by conventional techniques are not limited to segment boundaries but may occur throughout the entire curve segment, affecting the overall geometric fidelity of the transformation result.

The lower portion of the figure demonstrates the results obtained using the improved transformation techniques, showing an improved transformed curve 1010 that more closely approximates the correct curve 820 throughout the transformation domain. A first intermediate point 1008, a second intermediate point 1012, and a third intermediate point 1014 indicate specific locations where the improved technique achieves better geometric accuracy compared to the conventional approach. The improved transformed curve 1010 exhibits reduced deviations from the correct curve 820, demonstrating the enhanced accuracy achieved by the disclosed transformation methods.

The systematic evaluation of transformation accuracy at multiple points along the curve segment provides quantitative evidence of the improvements achieved by the disclosed techniques. The reduced deviations observed at the first intermediate point 1008, the second intermediate point 1012, and the third intermediate point 1014 indicate that the improved transformation methods maintain geometric accuracy throughout the entire curve segment, not just at the segment boundaries where continuity properties are explicitly preserved. This comprehensive accuracy improvement ensures that the transformed graphics maintain high visual quality and mathematical precision across all aspects of the transformation process.

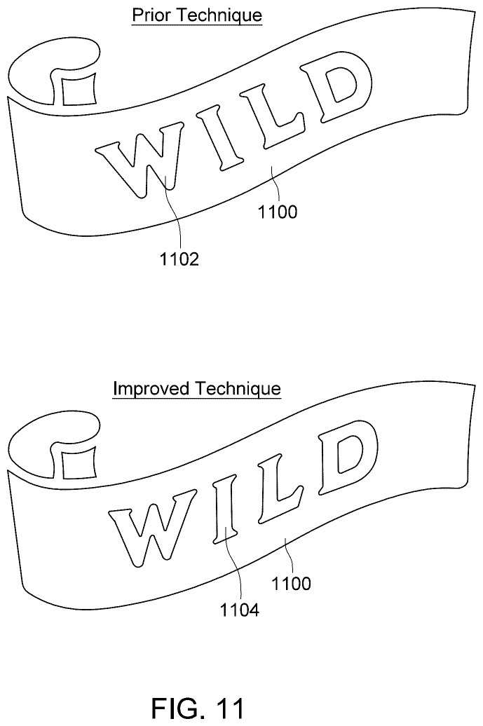

FIG. 11 illustrates different text-on-a-path results between prior techniques and the improved technique according to various embodiments. The practical application demonstrates how the disclosed transformation methods may be applied to text-on-a-path applications where text is warped to follow the contour of a curved path. The text-on-a-path scenario represents a common vector graphics application where the quality of nonaffine transformations directly impacts the visual appearance and readability of the final output, making the improvements achieved by the disclosed techniques particularly valuable for practical graphics applications.

A ribbon background 1100 provides the curved path that defines the spatial trajectory for the text placement operation. The ribbon background 1100 exhibits curvature and geometric properties that require nonaffine transformation techniques to properly map text characters onto the curved surface while maintaining appropriate spacing, orientation, and visual coherence. The curved geometry of the ribbon background 1100 presents challenges for text placement algorithms, as the nonlinear spatial relationships require specialized processing to ensure that text characters conform properly to the path curvature while maintaining readability and aesthetic appeal.

The upper portion of the figure shows prior text 1102 that has been positioned along the ribbon background 1100 using conventional transformation techniques. The prior text 1102 exhibits irregularities and distortions that result from the limitations of conventional approaches when applied to the nonlinear geometric relationships of the curved path. The text characters in the prior text 1102 may exhibit inconsistent spacing, irregular orientation, or visual artifacts that compromise the readability and aesthetic quality of the text-on-path result. These limitations demonstrate the challenges associated with applying conventional transformation techniques to complex vector graphics applications that require high visual quality and geometric precision.

The lower portion of the figure demonstrates improved text 1104 that has been positioned along the ribbon background 1100 using the disclosed transformation techniques. The improved text 1104 exhibits enhanced conformity to the curvature of the ribbon background 1100, with text characters that maintain consistent spacing, appropriate orientation, and smooth transitions along the curved path. The improved transformation approach ensures that the text characters follow the geometric properties of the ribbon background 1100 while preserving the visual characteristics that are necessary for readability and aesthetic appeal.

The comparison between the prior text 1102 and the improved text 1104 illustrates the practical benefits achieved by the disclosed transformation methods in real-world graphics applications. The enhanced geometric accuracy and continuity preservation provided by the improved techniques result in text-on-path output that exhibits professional quality and visual appeal. The smooth conformity of the improved text 1104 to the ribbon background 1100 demonstrates how the disclosed methods enable the creation of high-quality vector graphics that maintain both mathematical precision and aesthetic excellence, making these techniques valuable for applications such as logo design, artistic typography, and decorative graphics.

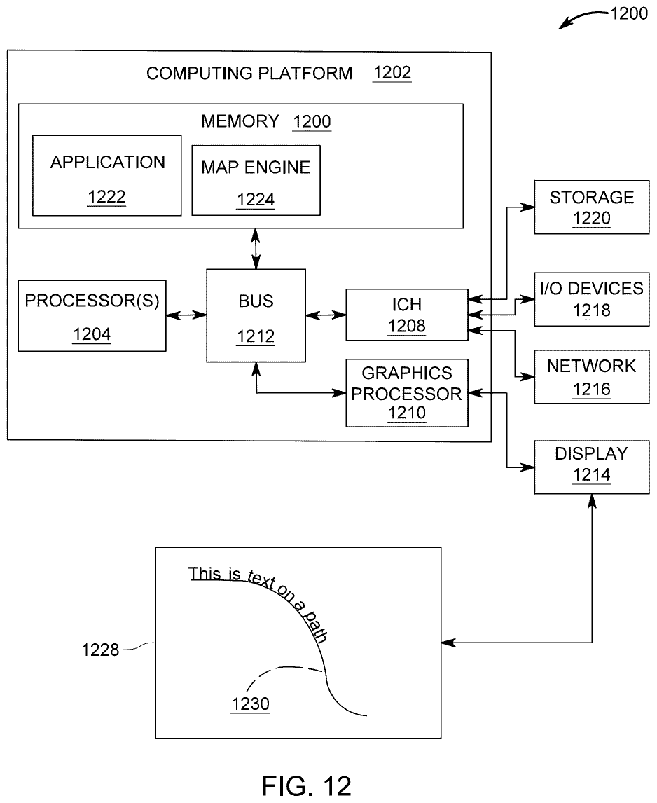

FIG. 12 illustrates a functional block diagram of a computing system suitable for implementing the improved methods disclosed herein according to various embodiments. The computing system 1200 provides the hardware and software architecture necessary for executing the nonaffine transformation algorithms while maintaining the computational precision and processing efficiency demanded by complex vector graphics operations. A computing platform 1202 within the computing system 1200 establishes the hardware framework that supports the mathematical calculations, memory management, and input/output operations associated with the transformation processes. The computing platform 1202 integrates multiple specialized components that work in coordination to provide the computational capabilities necessary for processing vector graphic paths comprising multiple connected segments, where each segment may be represented as a cubic path defined by control points.

A processor 1204 serves as the central computational unit within the computing platform 1202, executing the mathematical operations associated with determining transformed on-curve points by mapping on-curve points of the cubic path to a target transformation space. The processor 1204 handles the complex calculations involved in applying Jacobian matrix operations or numerical approximation techniques to determine transformed tangent vectors at the on-curve points. The computational architecture of the processor 1204 enables the execution of iterative algorithms that may subdivide segments of the transformed cubic path into smaller segments when an error between the transformed segment and the target transformation exceeds a predetermined threshold. The processor 1204 coordinates with other system components through a system bus 1212 that facilitates high-speed data transfer and communication between the various hardware elements of the computing platform 1202. The computing platform 1202 also includes memory that stores the application module 1222 and mapping engine 1224 components.

The system bus 1212 provides the communication infrastructure that enables coordinated operation between the processor 1204, memory systems, and specialized processing units within the computing platform 1202. A graphics processor 1210 connects to the system bus 1212 and provides specialized computational capabilities for rendering operations and visual output generation. The graphics processor 1210 may handle the final rendering stages of the transformation process, converting the mathematically transformed vector graphics into visual representations that may be displayed or output in various formats. An input control hub 1208 facilitates connections between the system bus 1212 and various peripheral devices, enabling user interaction and external data communication capabilities. The input control hub 1208 manages the flow of information between the computational core of the computing platform 1202 and external interfaces that support user input, network communication, and data storage operations.

A display device 1214 connects to the graphics processor 1210 and provides visual output capabilities for the computing system 1200. The display device 1214 may render the results of the nonaffine transformation operations, enabling users to visualize the transformed vector graphics and assess the quality of the transformation results. The display device 1214 may show display output 1228 that demonstrates the practical application of the transformation algorithms, such as text positioned along a curved path 1230 that illustrates the text-on-a-path capabilities enabled by the disclosed transformation methods. The curved path 1230 represents the type of complex geometric element that benefits from the improved continuity preservation and geometric accuracy provided by the disclosed transformation techniques.

A network interface 1216 connects through the input control hub 1208 and enables communication with external systems and services. The network interface 1216 supports implementation of the transformation methods as software-as-a-service (SaaS) that may be centrally hosted in the cloud and licensed on a subscription basis. The cloud-based implementation enables users to access the transformation capabilities through network connections without requiring local installation of the computational algorithms or specialized hardware. Input output devices 1218 provide user interaction capabilities, enabling operators to specify transformation parameters, select vector graphics elements for processing, and control the execution of the transformation algorithms. A storage device 1220 provides persistent data storage capabilities for vector graphics files, transformation parameters, and intermediate computational results generated during the transformation process. All of these peripheral components connect to the computing platform 1202 through the input control hub 1208.

The computing platform 1202 incorporates software components that implement the mathematical algorithms and processing logic associated with the nonaffine transformation methods. An application module 1222 represents the software framework that coordinates the transformation operations and provides user interface capabilities for interacting with the vector graphics processing system. The application module 1222 may handle file input and output operations, user interface management, and coordination of the various computational processes involved in the transformation operations. The application module 1222 works in conjunction with specialized processing components to execute the complete transformation workflow from initial vector graphics input through final output generation.

A mapping engine 1224 provides the specialized computational algorithms that implement the core transformation mathematics, including the determination of transformed tangent vectors through Jacobian matrix calculations or numerical approximation techniques. The mapping engine 1224 executes the mathematical operations associated with constructing transformed cubic paths in the target transformation space using the transformed on-curve points and the transformed tangent vectors, where C¹ continuity exists between adjacent segments of the path. The mapping engine 1224 may implement the Jacobian matrix computations as 2×2 matrices representing local linear approximations of the transformation mapping at the on-curve points. The mapping engine 1224 may also execute numerical approximation algorithms that scale tangent vector perturbations by factors inversely proportional to the length of the tangent vector, where the factor may be computed as k divided by the length of the tangent vector, with k representing a small distance relative to the size of the segment.

The computing system 1200 may incorporate machine learning or artificial intelligence models that can improve automatically through experience and using data. The machine learning implementation may use hardware optimized for machine learning functions, such as field-programmable gate arrays (FPGA) or graphics processing units (GPU) that provide parallel processing capabilities for complex mathematical operations. The machine learning components may analyze transformation results and automatically adjust algorithm parameters to improve accuracy or computational efficiency based on historical performance data. The artificial intelligence capabilities may enable the system to automatically select appropriate transformation techniques based on the characteristics of the input vector graphics or the specified transformation requirements.

The transformation mapping implemented by the mapping engine 1224 may be defined by a function from [symbol] ² to [symbol] ² that preserves the geometric integrity of the vector graphic path during the coordinate space conversion process. The mapping engine 1224 may support Coons patch transformations for mapping on-curve points to the target transformation space, enabling complex surface interpolation operations that maintain smooth geometric relationships between boundary elements. The transformed cubic path generated by the mapping engine 1224 may be defined using pairs of transformed control points, pairs of transformed tangent points, and pairs of terminal points in the target transformation space. The mapping engine 1224 may execute subdivision algorithms iteratively until transformation errors fall within predetermined thresholds while maintaining C¹ continuity between segments, ensuring that the final results achieve the desired balance between computational efficiency and geometric accuracy.

The computing system 1200 enables the generation of transformed vector graphics that may be rendered in standard formats comprising Scalable Vector Graphics (SVG), PDF, or PostScript, facilitating integration with existing graphics processing workflows and applications. The display output 1228 generated by the computing system 1200 demonstrates the practical benefits of the improved transformation techniques, showing how text and other vector graphics elements may be positioned along complex curved paths while maintaining visual quality and geometric precision. The curved path 1230 shown in the display output 1228 illustrates the type of nonaffine transformation that benefits from the specialized processing capabilities provided by the computing system 1200, demonstrating how the disclosed methods enable the creation of professional-quality vector graphics that maintain both mathematical accuracy and aesthetic appeal.

Machine readable storage including machine-readable instructions, when executed, to implement a method or realize a computing system in any of the examples of the present application. Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes a computing system for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or use the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

A component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present subject matter. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present subject matter may be referred to herein along with alternatives for the various components thereof. It is understood that such embodiments, examples, and alternatives are not to be construed as de facto equivalents of one another, but are to be considered as separate and autonomous representations of the present subject matter.

Although the foregoing has been described in some detail for purposes of clarity, it will be apparent that certain changes and modifications may be made without departing from the principles thereof. It should be noted that there are many alternative ways of implementing both the processes and computing systems described herein. Accordingly, the present embodiments are to be considered illustrative and not restrictive, and the subject matter is not to be limited to the details given herein, but may be modified within the scope and equivalents of the appended claims.

Those having skill in the art will appreciate that many changes may be made to the details of the above-described embodiments without departing from the underlying principles of the subject matter. The scope of the present subject matter should, therefore, be determined only by the following claims.

What is claimed is:

1. A method of performing nonaffine transformations on vector graphic paths comprising multiple connected segments, wherein each segment is represented as a cubic Bézier curve defined by control points, comprising:
determining transformed on-curve points by mapping on-curve points of the cubic Bézier curve to a target transformation space;
determining transformed tangent vectors at the on-curve points by one of:
applying a Jacobian matrix of the transformation mapping at the on-curve points to the tangent vectors of the original curve; and
numerically approximating the transformed tangent vectors by perturbing the on-curve points in the direction of the tangent vectors and mapping the perturbed points to the target transformation space; and
constructing a transformed cubic Bézier curve in the target transformation space using the transformed on-curve points and the transformed tangent vectors, wherein C¹ continuity exists between adjacent segments of the path.

2. The method of claim 1, wherein the mapping of on-curve points to the target transformation space is performed using a Coons patch transformation.

3. The method of claim 1, wherein the Jacobian matrix is computed as a 2×2 matrix representing a local linear approximation of the transformation mapping at the on-curve points.

4. The method of claim 1, wherein the tangent vector perturbation in the numerical approximation approach is scaled by a factor inversely proportional to the length of the tangent vector.

5. The method of claim 4, wherein the factor is computed as k divided by the length of the tangent vector, where k is a small distance relative to the size of the segment.

6. The method of claim 1, wherein the transformation mapping is defined by a function from R² to R² that preserves the geometric integrity of the path.

7. The method of claim 1, further comprising a step of subdividing a segment of the transformed cubic Bézier curve into smaller segments when an error between the transformed segment and the target transformation exceeds a predetermined threshold.

8. The method of claim 7, wherein the subdivisions are performed iteratively until the error is within the predetermined threshold while maintaining C¹ continuity between segments.

9. The method of claim 1, wherein the transformed cubic Bézier curve is defined using a pair of transformed control points, a pair of transformed tangent points, and a pair of terminal points in the target transformation space.

10. The method of claim 1, wherein the transformed path is used to render vector graphics in formats comprising Scalable Vector Graphics (SVG), PDF, or PostScript.

11. A computing system, comprising:
a processor; and
a memory coupled to the processor and configured to store instructions that, when executed by the processor, cause the processor to perform operations comprising:
determining transformed on-curve points by mapping on-curve points of a cubic Bézier curve to a target transformation space, wherein the cubic Bézier curve represents a segment of a vector graphic path comprising multiple connected segments;
determining transformed tangent vectors at the on-curve points by one of:
applying a Jacobian matrix of the transformation mapping at the on-curve points to the tangent vectors of the original curve; and
numerically approximating the transformed tangent vectors by perturbing the on-curve points in the direction of the tangent vectors and mapping the perturbed points to the target transformation space; and
constructing a transformed cubic Bézier curve in the target transformation space using the transformed on-curve points and the transformed tangent vectors, wherein C¹ continuity exists between adjacent segments of the vector graphic path.

12. The computing system of claim 11, wherein the mapping of on-curve points to the target transformation space is performed using a Coons patch transformation.

13. The computing system of claim 11, wherein the Jacobian matrix is computed as a 2×2 matrix representing a local linear approximation of the transformation mapping at the on-curve points.

14. The computing system of claim 11, wherein the tangent vector perturbation in the numerical approximation approach is scaled by a factor inversely proportional to the length of the tangent vector.

15. The computing system of claim 14, wherein the factor is computed as k divided by the length of the tangent vector, where k is a small distance relative to the size of the segment.

16. The computing system of claim 11, wherein the operations further comprise a step of subdividing a segment of the transformed cubic Bézier curve into smaller segments when an error between the transformed segment and the target transformation exceeds a predetermined threshold.

17. The computing system of claim 16, wherein the subdivisions are performed iteratively until the error is within the predetermined threshold while maintaining C¹ continuity between segments.

18. The computing system of claim 11, wherein the transformed cubic Bézier curve is defined using a pair of transformed control points, a pair of transformed tangent points, and a pair of terminal points in the target transformation space.

19. The computing system of claim 11, wherein the transformation mapping is defined by a function from R² to R² that preserves the geometric integrity of the vector graphic path.

20. The computing system of claim 11, wherein the transformed cubic Bézier curve is used to render vector graphics in formats comprising Scalable Vector Graphics (SVG), PDF, or PostScript.
